(19) United States
(12) Patent Application Publication
(10) Pub. No.: US 2014/0334594 A1
(43) Pub. Date: Nov. 13, 2014

(54) NUCLEAR REACTOR PRIMARY CIRCUIT, WITH A BRANCH EQUIPPED WITH A THERMAL SLEEVE

(71) Applicant: AREVA NP, Courbevole (FR)

(72) Inventors: Olivier Cartier, Versailles (FR); Christel Dumez, Savigny Sur Orge (FR); Thierry Muller, St. Helene (FR); Thierry Balancon, Epernon (FR)

(21) Appl. No.: 14/369,142

(22) PCT Filed: Dec. 24, 2012
(86) PCT No.: PCT/EP2012/076888

§ 371 Date: Jun. 26, 2014

(30) Foreign Application Priority Data
Dec. 29, 2011 (FR) 1162551

(51) Int. Cl. B01F 3/08; G21C 15/22; G21C 13/032

(52) U.S. Cl. CPC B01F 3/0865; G21C 13/032; G21C 15/22
USPC 376/395

(57) ABSTRACT

A nuclear reactor primary circuit with a branch equipped with a thermal sleeve is provided. The nuclear reactor primary circuit includes a primary tubing, having an inner surface delimiting an inner volume in which a primary fluid circulates for cooling the nuclear reactor; a branch fastened to the primary tubing and delimiting an inner passage communicating with the inner volume of the primary tubing; a sleeve, having a first end connected to the branch and a second free end engaged in the inner volume of the primary tubing, the second end protruding in the inner volume relative to the inner surface over a non-zero length, an annular space being delimited between the sleeve and the branch. The primary circuit comprises a device making the sleeve unlosable, the unlosability device comprising at least one first raised portion formed on the branch, at least one second raised portion formed on the sleeve and capable of cooperating with the first raised portion to prevent the sleeve from falling into the primary tubing if the sleeve separates from the branch.

The invention generally relates to nuclear reactor primary circuits, with branches equipped with thermal sleeves.

More specifically, the invention relates to a nuclear reactor primary circuit, of the type comprising:

a primary tubing, having an inner surface delimiting an inner volume in which a primary fluid circulates for cooling the nuclear reactor;

a branch fastened to the primary tubing and delimiting an inner passage communicating with the inner volume of the primary tubing;

a sleeve, having a first end connected to the branch and a second free end engaged in the inner volume of the primary tubing, the second end protruding in the inner volume relative to the inner surface over a non-zero length, an annular space being delimited between the sleeve and the branch.

### BACKGROUND

One such primary circuit is known from document FR 2 893 755 A1, which describes that the free end of the sleeve has an upstream section that more deeply penetrates the inside of the primary tubing than the downstream section. The terms upstream and downstream are understood here relative to the normal direction of circulation of the primary fluid. Such an arrangement makes it possible to space the injection area away from the fluid arriving through the branch toward the center of the primary tubing. This is particularly advantageous when the related branch is provided to inject a fluid at a temperature different from that of the primary fluid, in particular a colder fluid. The branch and the inner surface of the primary tubing then only see a fluid at a temperature close to that of the primary fluid, and are not subjected to significant temperature fluctuations. Thermal fatigue at the branch is therefore lessened considerably.

Furthermore, the fact that the upstream sector of the sleeve penetrates more than the downstream sector makes it possible to greatly limit primary hot fluid vortex rising in the sleeve. This makes it possible to limit the thermal fatigue inside the sleeve.

### SUMMARY OF THE INVENTION

However, the fact that the sleeve protrudes in the inner volume of the primary tubing means that it is subject to a force resulting from the flow of the primary fluid. It may in particular vibrate under the effect of variations in the force applied by the flow of primary fluid.

If the sleeve detaches from the branch, it no longer performs its role in limiting the fatigue at the branch and it may be driven by the primary fluid and damage certain inner parts of the primary circuit.

In this context, an object of the invention is to provide a primary circuit resolving this problem.

A primary circuit is provided including a primary circuit including a device making the sleeve unlosable, the unlosability device comprising at least one first raised portion formed on the branch, at least one second raised portion formed on the sleeve and capable of cooperating with the first raised portion to prevent the sleeve from falling into the primary tubing if the sleeve separates from the branch.

Thus, in the event the sleeve detaches from the branch under the effect of stresses applied by the circulation of the primary fluid, the first and second raised portions prevent the sleeve from sliding to the inside of the primary tubing. The sleeve remains confined to the inside of the branch.

The branch is typically used to connect a related tubing, for example the feed line of the chemical and volume control (VCR) circuit, to the primary circuit. This tubing is tapped on the cold branch of the primary circuit, i.e., on the part of that circuit situated upstream of the vat of the nuclear reactor and connecting the circulation pump for the primary fluid to one of the inlets of the vat. The feed line makes it possible to inject a liquid charge from the VCR into the primary circuit, so as to upwardly adjust the volume of primary liquid circulating therein. The liquid charges thus injected are colder than the primary liquid circulating in the primary circuit.

Tapping may also be used to connect a related tubing coming from the pressurizer to the hot branch of the primary circuit. The hot branch is the part of the primary circuit connecting the VAT of the nuclear reactor to a steam generator. In certain situations, a very hot fluid circulates from the pressurizer into the primary circuit.

The sleeve is for example connected by its first end directly to the branch.

Alternatively, the first end of the sleeve is connected to the related tubing tapped on the primary tubing by means of the branch. In that case, the related tubing delimits an inner volume communicating with the inner volume of the primary tubing by means of the passage inside the branch. The sleeve passes all the way through the inner passage. The annular space in this case extends over the entire length of the inner passage and continues into the related tubing up to the junction point between the sleeve and the related tubing.

The inner passage of the branch is delimited by a peripheral surface. The first raised portions are typically raised portions protruding relative to the peripheral surface of the branch, inside the annular space.

The first raised portions may assume any shape. These are for example substantially parallelepiped studs. The studs may also be cylindrical, have an oval section, etc. The first raised portions may also have a circumferentially elongated shape, around the central axis of the inner passage, or parallel to said central axis.

The second raised portion protrudes relative to the radially outer surface of the sleeve, inside the annular space.

Along the central axis of the inner passage, the second raised portions are offset opposite the primary tubing relative to the first raised portions. The first and second raised portions are arranged such that, in the event the sleeve is detached from the branch, the second raised portions cannot cross the first raised portions, irrespective of the angular position of the sleeve relative to the branch around the central axis.

The fact that the second end of the sleeve protrudes in the inner volume of the primary tubing over a non-zero length here means that part of the sleeve is engaged inside the inner volume. For example, the sleeve is engaged in the inner volume over a length corresponding to at least 25% of its outer diameter considered at the second end, preferably over at least 50% of that diameter.

The sleeve may be of the type described in document FR 2 893 755 A1. It may thus include a second end whereof the free peripheral edge represents at least one upstream sector penetrating the inner volume of the downstream sector more deeply. Alternatively, the upstream and downstream sectors of the free edge are situated at the same depth in the inner volume.

Preferably, the primary circuit comprises raised portions arranged to create a path in the annular space for circulation of the primary fluid from an inlet area emerging in the inner volume to the bottom of the annular space, then from said bottom to an outlet area emerging in the inner volume.

The bottom of the annular space corresponds to the area of the annular space furthest from the primary tubing. It corresponds to the area in which the sleeve connects to the branch, or to the related tubing tapped on the primary tubing by the branch. The bottom is thus at least partially delimited by the first end of the sleeve.

In this way, a forced circulation of the primary fluid is created within the annular space. This makes it possible to avoid having areas of the annular space in which the circulation of the primary fluid is extremely reduced or nonexistent, or “dead zones” in which boron in particular risks building up. This forced circulation of the primary fluid in the entire annular space also aims to prevent gases (oxygen, hydrogen, nitrogen, etc.) from becoming concentrated in the annular space and aims to ensure maximum homogeneity between the primary fluid and the fluid circulating in the annular space (homogeneity of temperature and composition).

Preferably, the raised portions are arranged such that the primary fluid rises along the sleeve as far as the bottom of the annular space, then descends again along the sleeve as far as the outlet area. The circulation path thus includes a segment where the primary fluid is rising, typically turned in the upstream direction, and a segment where the primary fluid is descending, typically turned in the downstream direction. The terms upstream and downstream are understood here relative to the normal direction of circulation of the primary fluid in the inner volume of the primary tubing. In the rising section, the fluid circulates toward the bottom of the annular space, in a general direction substantially parallel to the central axis of the inner passage. In the descending segment, the circulation occurs in the opposite direction. The primary fluid thus sweeps over the entire annular space.

The inlet area and the outlet area are two areas of the annular opening through which the annular space emerges in the inner volume of the primary tubing. The inlet area typically corresponds to the half of the annular opening turned in the upstream direction, and the outlet area to the half of the annular opening turned in the downstream direction.

Preferably, none of the first raised portions are situated on an angular section of the peripheral surface of the inner passage that has an angular width 45°, facing an upstream side of the direction of circulation. Preferably, this angular sector free of all raised portions is greater than 80°.

In other words, the sector of the peripheral surface turned in the upstream direction does not bear first raised portions. These first raised portions may hinder the rising of the primary liquid in the annular space.

Preferably, the unlosability device comprises four raised portions, arranged at 90° relative to one another around the central axis of the inner passage. In relation to a plane containing the central axis of the inner passage and the central axis of the primary tubing, considered at the branch, the first raised portions are positioned at 45°.

Preferably, the second raised portion is a ring extending around the sleeve.

The ring has a generally annular shape, and protrudes over the radially outer surface of the sleeve, in the annular space. It is typically integral with the sleeve. The ring is typically continuous. Alternatively, it may be made up of several segments arranged circumferentially in the extension of one another, but spaced apart from one another. Preferably, the ring extends around the sleeve over an angular sector comprised between 240° and 330°, preferably between 260° and 310°, and for example between 280° in 300°.

In this way, the ring has a broken sector. This broken sector covers an angular sector comprised between 30° and 120°, preferably between 50° and 100°, for example between 60° and 80°.

In order to facilitate the circulation of the primary fluid along the circulation path, the broken sector is turned in the downstream direction.

The broken sector is thus preferably situated in the outlet area of the circulation path, therefore facilitating the exit of the primary fluid outside the circulation path. On the other hand, the sector of the ring located in the inlet area is not broken, but has a rounded edge turned toward the axis of the primary tubing to facilitate the rise of the primary fluid toward the annular space.

Preferably, the ring and the first raised portions are situated substantially at the same level along the central axis of the inner passage.

Preferably, the first and second raised portions are situated along the central axis at a distance of less than 60 mm, preferably less than 45 mm, from the opening through which the inner passage emerges into the inner volume of the primary tubing. Thus, the first and second raised portions are situated as close as possible to that opening, in an area where the speed of the primary fluid is sufficient to overcome the obstacle, so as to favor the circulation of the primary fluid within the annular space.

Advantageously, the ring has, for each first raised portion, a notch radially open toward a peripheral wall of the inner passage, open along the central axis of the inner passage toward the primary tubing, and closed along the central axis opposite the primary tubing, each first raised portion being engaged in the corresponding notch without contact with the ring.

This arrangement therefore makes it possible to arrange the ring and the first raised portions substantially at the same level along the central axis and therefore to position the ring in a position as close as possible to the opening of the inner passage of the branch toward the primary tubing.

Preferably, the ring has a rounded leading edge on its surface turned toward the inner volume of the primary tubing and the second free end of the sleeve has a smaller thickness than that of the sleeve in its portion situated in the annular space, so as to form an outer surface of the sleeve that is tapered at the opening of the annular space on the primary tubing.

The thickness transitions in the bottom of the sleeve and the rounded leading edge of the ring thereby favor rising of the primary fluid in the annular space.

Typically, the primary circuit includes at least two ribs extending the annular space, substantially parallel to the central axis of the inner passage, said ribs being positioned on two opposite sides of the sleeve.

Typically, these two ribs are formed on the radially outer surface of the sleeve. They protrude into the annular space. Alternatively, the two ribs are formed or attached on the peripheral wall of the inner passage.

Relative to the sleeve, the ribs protrude substantially over the same height as the ring defining the second raised portion.

The two ribs extend, parallel to the central axis, from the ring, in a direction opposite the primary tubing. Typically, a first end of each rib is directly connected to the ring. The opposite end stops at a distance from the bottom of the annular space, i.e. at a distance from the area where the sleeve connects to the branch.

Preferably, the ribs extend over a height representing between 40% and 60% of the total height of the annular space, in a direction parallel to the central axis of the inner passage, between the bottom of the annular space and the portion of the annular space that emerges on the primary tubing.

The two ribs are typically rectilinear. Alternatively, they are partially or completely bowed.

The two ribs therefore subdivide the annular space into two circumferential portions, communicating with each other at the bottom of the annular space. The inlet area of the circulation path emerges in one of the two portions, and the outlet area in the other of the two portions. These two portions correspond to the rising and descending sections of the circulation path.

Preferably, the two ribs are diametrically opposite around the sleeve. In this way, the respective passage sections of the two sleeves of the circulation path are substantially equal to one another.

Preferably, the two ribs fit into a first plane, forming an angle comprised between 45° and 90° with a second plane containing the central axis of the inner passage and the central axis of the primary tubing considered at the branch.

This facilitates the bypass of the primary fluid toward the rising segment.

Thus, when for example the central axis of the inner passage is perpendicular to the central axis of the primary tubing, the two ribs are in a plane substantially perpendicular to the central axis of the primary tubing. The portion of the annular space corresponding to the rising segment of each circulation path is turned in the upstream direction, and the other portion in the downstream direction.

The primary circuit could include more than two ribs, for example four ribs dividing the annular space into four circumferential portions. The rising segment of the passage path then corresponds to the two portions turned in the upstream direction, the descending segment to the two portions turned in the downstream direction.

Above we have described that the ring is borne by the sleeve, and the studs by the branch. However, it is possible to arrange these elements in the opposite manner, the studs being borne by the sleeve and the ring by the branch.

### BRIEF SUMMARY OF THE DRAWINGS

Other features and advantages of the invention will emerge from the detailed description thereof provided below, for information and non-limitingly, in reference to the appended figures, in which:

FIG. 1 is a general diagrammatic view of the primary portion of a pressurized water nuclear reactor;

FIG. 2 is an enlarged cross-sectional view of a detail II of FIG. 1, showing the interface between the feed line connected to the VCR circuit and the primary tubing;

FIG. 3 is a perspective view of part of the sleeve of FIG. 2;

FIG. 4 is a cross-section along the arrows IV of FIG. 2;

FIG. 5 is a cross-section along the arrows V of FIG. 2;

FIG. 6 is a partial cross-section along the arrows VI of FIG. 4.

### DETAILED DESCRIPTION

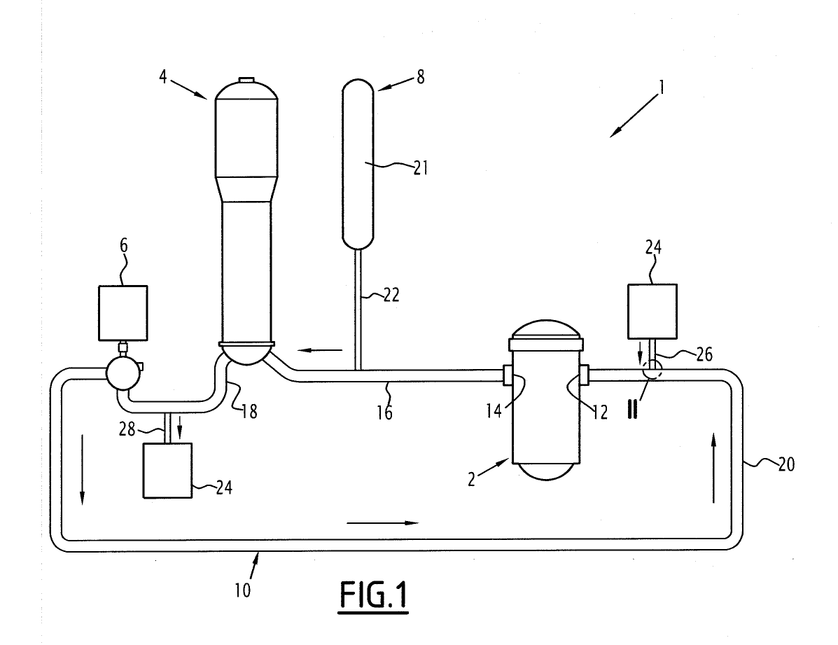

The nuclear reactor 1 partially shown in FIG. 1 comprises a vat 2 containing nuclear fuel assemblies, a steam generator 4, a primary pump 6, a pressurizer 8 and a primary circuit 10. The vat 2 is provided with at least one inlet 12 and an outlet 14. The primary circuit 10 comprises a hot branch 16 connecting the outlet 14 of the vat 2 to the steam generator 4, a U-shaped branch 18 connecting the steam generator 4 to the primary pump 6, and a cold branch 20 connecting the pump 6 to the inlet 12 of the vat 2.

The primary circuit 10 contains a primary fluid, typically water, circulating in a closed circuit. The primary fluid is discharged by the primary pump 6 to the vat 2, passes through said vat while heating in contact with the nuclear fuel assemblies, then transfers its heat to a secondary fluid circulating in a secondary circuit (not shown) by passing into the steam generator 4.

The pressurizer 8 is primarily made up of a sealed iron enclosure 21, in communication with the inner volume of the hot branch 16 by means of the tubing 22 tapped on said hot branch 16. The enclosure 21 is partially filled with the primary fluid, the roof at the top of said enclosure being occupied by the pressurized steam in hydrostatic equilibrium with the primary fluid. The pressurizer 8 also comprises means (not shown) for varying the pressure of steam in a controlled manner in the roof of the enclosure 21, so as to adjust the pressure of the primary fluid in the circuit 10.

The reactor also comprises a circuit 24 for chemical and volume control, called the Volume Control Reactor (VCR) circuit, shown diagrammatically in FIG. 1. The VCR circuit is capable of varying the volume of primary fluid circulating in the circuit 10 in a controlled manner, by injecting fluid charges in the primary circuit, or removing fluid charges from that circuit. To that end, the primary circuit 10 comprises a feed line 26 connected to the VCR circuit 24 and tapped on the cold branch 20 of the primary circuit 10.

The primary circuit 10 also comprises a removal tubing 28 tapped at the lowest point of the U-shaped branch 18 of the primary circuit 10.

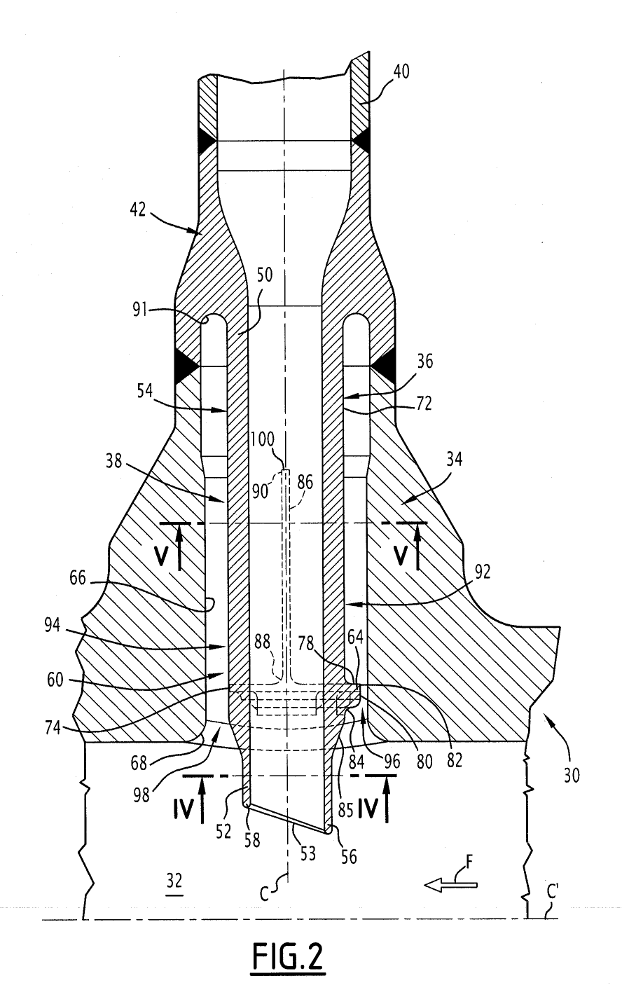

The interface between the feed line 26 and the cold branch 20 of the primary circuit is illustrated in FIG. 2. The cold branch 20 comprises a cylindrical primary tubing 30 delimiting an inner volume 32 in which the primary fluid circulates, said fluid circulating from the upstream of the primary tubing, i.e., the pump 6, toward the downstream of the primary tubing, i.e., toward the inlet 12 of the vat 2. The central axis C′ of the primary tubing 30 is horizontal in FIG. 2. The circuit also comprises a branch 34 for connecting the feed line 26 to the primary tubing 30, and an inner protective sleeve 36.

The branch 34 is welded in an opening of the tubing 30, and inwardly defines an inner passage 38 connecting substantially perpendicularly from the inner volume 32 of the tubing 30. The passage 38 is substantially cylindrical. It puts the inner volume of the feed line 26 in communication with the inner volume 32 of the primary tubing 30.

The feed line 26 comprises a main portion 40 that is substantially cylindrical, with a reduced inner diameter relative to the inner diameter of the passage 38, and an intermediate portion 42 inserted between the main portion 40 and the branch 34.

The intermediate portion 42, the main portion 40 and the passage 38 are coaxial, with a central axis C that is substantially radial relative to the primary tubing 30.

The sleeve has a generally cylindrical shape, with central axis C. It has a first end 50 secured to the inner surface of the feed line 26. More specifically, said first end 50 is integral with an inner portion of the intermediate portion 42. The sleeve 36 extends, substantially rectilinearly, from said first end 50 as far as a second free end 52 situated in the inner volume 32 of the primary tubing 30. The sleeve 36 therefore extends inside the inner passage 38. It has a reduced outer diameter relative to the inner passage 38, such that an annular space 54 is delimited between the sleeve 36 on the one hand and the intermediate portion 42 and the branch 34 on the other hand. The space 54 is open toward the bottom of FIG. 2 and emerges in the inner volume 32 of the primary tubing 30. It is upwardly closed in FIG. 2, by the junction area between the sleeve 36 and the portion 42.

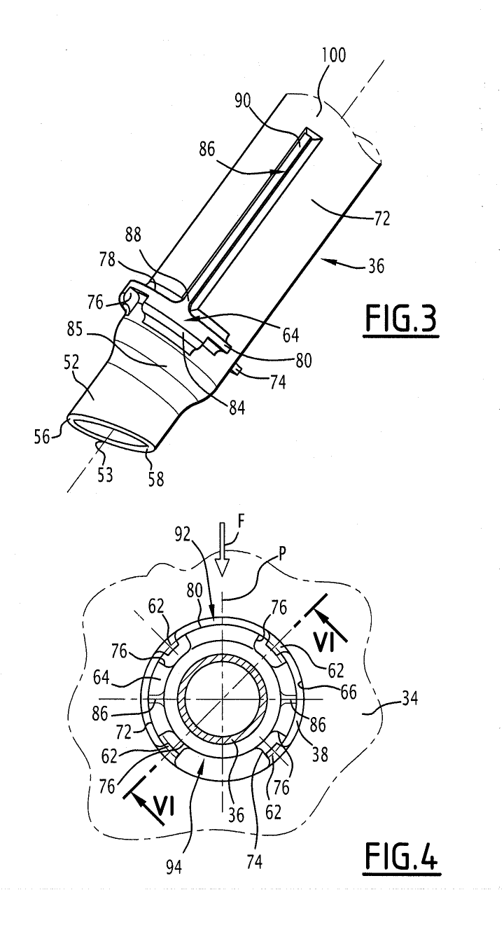

The second end 52 of the sleeve is limited by a free peripheral edge 53 having a beveled profile. As shown in FIGS. 2 and 3, this peripheral edge has upstream and downstream sectors 56 and 58, respectively turned in the upstream and downstream directions of the primary tubing 30. The direction of circulation of the primary fluid is shown by the arrow F in FIG. 2.

Because the peripheral edge 53 is beveled, the upstream sector 56 of the peripheral edge more deeply penetrates the inner volume 32 of the primary tubing in the downstream sector 58.

The depth of penetration of a point of the peripheral edge 53 here refers to the distance separating that point from the opening of the inner passage 38 emerging in the inner volume 32, that distance being considered substantially radially relative to the central axis C′ of the primary tubing 30.

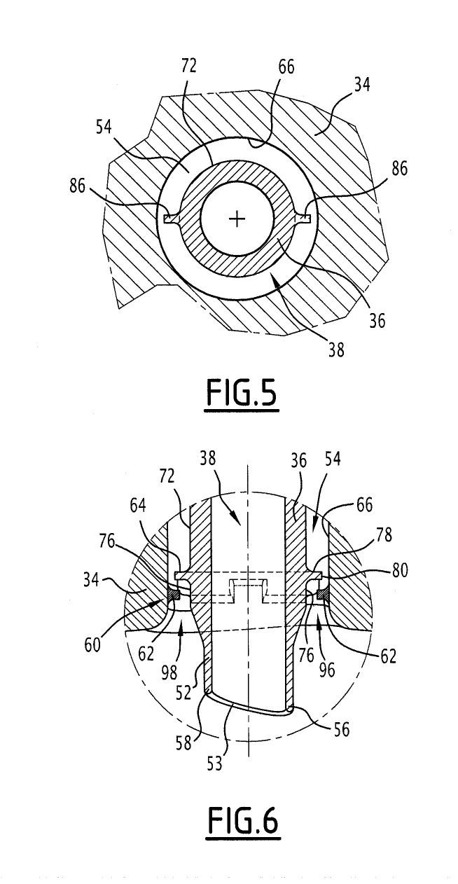

A device 60 making the sleeve 36 unlosable is provided to prevent the sleeve 36 from falling inside the primary tubing 30. The device 60 includes a plurality of studs 62 (shown in FIGS. 4 and 6) borne by the branch 34, and a ring 64, formed on the sleeve 36.

The studs 62 have generally parallelepiped shapes. They are attached on a peripheral wall 66 delimiting the inner passage 38. They are distributed at 90° relative to one another around the axis C. They protrude into the annular space 54. As shown in particular in FIG. 6, the studs 62 are placed in the immediate vicinity of the opening 68 through which the inner passage 38 emerges in the inner volume of the primary tubing.

The plane P containing the central axes C and C′ is shown in FIG. 4. The studs 62 are distributed around the axis C in directions forming 45° angles relative to the plane P, as shown in FIG. 4.

In this way, none of the studs 62 are situated on an angular sector of 80° of the peripheral wall 66, turned in the upstream direction in the direction C′. This angular sector extends over 40° on either side of the plane P of FIG. 4.

As shown in FIG. 2, the sleeve 36 is delimited radially outwardly by a substantially cylindrical surface 72, turned toward the branch. The annular space 54 is delimited between the surface 72 and the peripheral wall 66. The ring 64 protrudes radially toward the outside of the sleeve relative to the surface 72. It protrudes toward the inside of the annular space 54. The ring 64 extends in a plane substantially perpendicular to the axis C. It is in the form of a broken ring, having an open sector 74 (see FIG. 4). The open sector 74 extends over approximately 76°, around the axis C. It is turned in the downstream direction, as shown in FIG. 4. The ring 64 radially has a width chosen so that the interstice between the ring and the peripheral wall 66 is for example 5 mm.

Considered along the axis C, the ring extends substantially at the same level as the studs 62.

To make it possible to position the ring 64 as close as possible to the opening 68 of the inner passage 38, the ring includes four notches 76, in particular visible in FIGS. 3, 4 and 6, to house the studs 62. Each notch 76 is radially outwardly opened, i.e. toward the peripheral wall 66. Each notch 76 is also open along the axis C, toward the primary tubing 30. However, the notches 76 are axially closed opposite the primary tubing, i.e. toward the related tubing 40.

The height of the studs 62 relative to the peripheral wall 66 is such that the free end of the studs 62 is engaged inside the corresponding notch 76 with play relative to the notch such that during normal operation, there is no contact between the studs 62 and the notches 76. In the case where the sleeve 36 is detached, the ring 64 would be blocked in translation toward the inside of the primary tubing by the studs 62 coming into contact with the notches 76.

As shown in FIGS. 2 and 3, the ring 64 is delimited toward the related tubing 40 by a substantially planar surface 78. The surface 78 is substantially perpendicular to the axis C. The edge 82 ensuring the junction of the surface 78 with the edge 80 of the ring is a square edge. However, the ring 64 is delimited toward the primary tubing by a surface 84 having very gentle shapes. In particular, the transition between the surface 84 and the edge 80 has a rounded shape. The sleeve 36 also has, in the portion thereof situated just below the ring 64 in FIG. 2, a tapered outer surface 85 that forms another gentle transition toward the end 52 of the sleeve. The sleeve in fact has a smaller thickness at its end 52 than in its portion situated inside the inner portion 38 thereby forming a conical transition at the surface 85 that is situated across from the opening 68 of the inner passage 38. The effect of this tapered shape and the rounded shape between the surface 84 and the edge 80 is to facilitate the rise of the primary fluid in the annular space.

In fact, even if the passage section of the primary fluid is more reduced in the inlet area 96, the fluid arrives from the primary tubing 30 with a sufficient speed to rise in the annular space 54 despite the passage restriction at the ring 64.

As shown in FIG. 3, the sleeve 36 bears two ribs 86 on its outer surface 72.

The ribs 86 extend from the ring 64, parallel to the axis C, toward the bottom of the annular space 54. The ribs 86 are rectilinear. They are diametrically opposite relative to the axis C. They each have a first end 88 directly connected to the ring 64. They each have a second end 90 stopping at a distance from the bottom 91 of the annular space 54. The ribs 86 have a thickness relative to the outer surface 72 that is substantially equal to that of the ring 64. In this way, the edge of the rib 86 is separated from the peripheral wall 66 by an interstice with a width of approximately 5 mm.

The ribs 86 have a height, in the direction of the axis C between the first end 88 and the second end 90, that substantially corresponds to half of the total height of the annular space 54 between the bottom 91 and the opening 68.

The two ribs 86 fit into a same plane, containing the axis C, said plane being substantially perpendicular to the central axis C′ of the primary tubing.

The two ribs 86 divide the annular space 54 into two portions. Each of the two portions extends circumferentially around half of the sleeve 38. The first portion 92 is turned in the upstream direction, while the second portion 94 is turned in the downstream direction. Together, the portions 92 and 94 make up a circulation path for the primary fluid in the annular space, from an inlet area 96 communicating with the inner volume 32 of the primary tubing to an outlet area 98 also communicating with the inner volume 32. The inlet area 96 corresponds to the area through which the portion 92 emerges in the inner volume 32. This inlet area 96 also corresponds to the area of the annular opening situated in the extension of the portion 92.

As shown in particular in FIG. 6, two of the studs 62 and part of the ring 64 form a restriction in the inlet area 96. The passage section offered to the primary fluid at the restriction is reduced, and is smaller than the passage section offered downstream of the restriction in the portion 92 of the annular space.

As shown for example in FIG. 4, the ring 64 extends over the entire circumferential width of the portion 92.

Symmetrically, the outlet area 98 corresponds to the area through which the portion 94 emerges in the inner volume 32.

This area 98 is situated at the open end of the annular space 54. This area corresponds substantially to the area of the annular opening that is situated in the extension of the portion 94.

As shown in particular in FIG. 4, the passage section offered to the primary fluid in the outlet area 98 is larger than the inlet area 96. In fact, the open sector 74 is situated in the outlet area 98. In this way, the ring 64 does not extend over the entire circumferential width of the portion 94. It only covers approximately two thirds of that width.

Furthermore, the portions 92 and 94 communicate with each other at the bottom of the annular space. This is obtained due to the fact that the ribs 86 do not extend as far as the bottom 91. Two openings 100 therefore exist, diametrically opposite each other, between the ends 90 of the ribs and the bottom 91. The passage section offered to the primary fluid together by the two openings 100 is greater than or equal to the passage section offered to the primary fluid at the restriction of the inlet 96.

The circulation of the primary fluid will now be described.

The primary fluid circulates in the inner volume 32 of the primary tubing, from upstream to downstream. The direction of circulation is shown by the arrow F in FIG. 2. The free end 53 of the sleeve penetrates inside the inner volume 32. As a result, the mixing area between the cold fluid arriving through the related tubing 40 and the hot primary fluid circulating in the primary tubing is offset far from the opening 68 of the bridge.

Part of the primary fluid penetrates the annular space 54 through the inlet area 96. The tapered shape of the surface 85 and the rounded shape of the surface of the ring 64 turned toward the inner volume 32 of the primary tubing as well as the passage section between the edge 80 of the ring and the peripheral wall 66 are provided to ensure continuous circulation from the inlet area to the outlet area, such that the entire annular space 54 is traveled by the primary fluid.

After having crossed the restriction formed by the studs and the ring, the primary fluid rises again in the portion 92 of the annular space up to the openings 100, along the sleeve 36. At the openings 100, the primary fluid flows circumferentially around the sleeve 36 and penetrates the portion 94 of the annular space. The primary fluid then descends again along the sleeve 36 by the portion 94 up to the outlet area 98. The passage section at the outlet area 98 is sufficient not to hinder the proper circulation of the primary fluid. The primary fluid then rejoins the inner volume 32 of the primary tubing.

1-13. (canceled)

14. A nuclear reactor primary circuit of a nuclear reactor comprising:
a primary tubing having an inner surface delimiting an inner volume in which a primary fluid circulates for cooling the nuclear reactor;
a branch fastened to the primary tubing and delimiting an inner passage communicating with the inner volume of the primary tubing;
a sleeve having a first end connected to the branch and a second free end engaged in the inner volume of the primary tubing, the second end protruding in the inner volume relative to the inner surface over a non-zero length, an annular space being delimited between the sleeve and the branch; and
an unlosability device making the sleeve unlosable, the unlosability device including at least one first raised portion formed on the branch, at least one second raised portion formed on the sleeve and capable of cooperating with the first raised portion to prevent the sleeve from falling into the primary tubing if the sleeve separates from the branch.

15. The circuit as recited in claim 14 further comprising raised portions arranged to create a path in the annular space for circulation of the primary fluid from an inlet area emerging in the inner volume to the bottom of the annular space, then from the bottom to an outlet area emerging in the inner volume.

16. The circuit as recited in claim 14 wherein the inner passage is delimited by a peripheral surface, the primary fluid circulating in the primary tubing from upstream to downstream in a direction of circulation, none of the first raised portions being situated on an angular sector of the peripheral surface with an angular width of 45° facing an upstream side of the direction of circulation.

17. The circuit as recited in claim 14 wherein the second raised portion is a ring extending around the sleeve.

18. The circuit as recited in claim 17 wherein the ring extends around the sleeve over an angular sector comprised between 240° and 330°.

19. The circuit as recited in claim 17 wherein the inner passage has a central axis, the ring and the first raised portions being situated substantially at the same level along the central axis.

20. The circuit as recited in claim 17 wherein the inner passage has a central axis, the ring having at least one notch radially open toward a peripheral wall of the inner passage, open along the central axis toward the primary tubing, closed along the central axis opposite the primary tubing, the first raised portion being engaged in the notch without contact with the ring.

21. The circuit as recited in claim 17 wherein the primary fluid circulates in the primary tubing from upstream to downstream in a direction of circulation, the ring having a broken sector turned in the downstream direction along the direction of circulation.

22. The circuit as recited in claim 17 wherein the ring has a rounded leading edge on its surface turned toward the inner volume of the primary tubing and the second free end of the sleeve has a smaller thickness than that of the sleeve in its portion situated in the annular space, so as to form an outer surface of the sleeve that is tapered at the opening of the annular space on the primary tubing.

23. The circuit as recited in claim 14 wherein the inner passage has a central axis and emerges through an opening in the inner volume of the primary tubing, the first and second raised portions being situated along the central axis at a distance of less than 60 mm from the opening.

24. The circuit as recited in claim 14 further comprising at least two ribs extending the annular space, substantially parallel to a central axis of the inner passage, the ribs being positioned on two opposite sides of the sleeve.

25. The circuit as recited in claim 24 wherein the two ribs are diametrically opposite around the sleeve and fit into a first plane, the first plane forming an angle comprised between 45° and 90° with a second plane containing the central axis of the inner passage and the central axis of the primary tubing considered at the branch.

26. The circuit as recited in claim 24 wherein the ribs extend over a height representing between 40% and 60% of the total height of the annular space, in a direction parallel to the central axis of the inner passage, between the bottom of the annular space and the portion of the annular space that emerges on the primary tubing.
